(19) United States
(12) Patent Application Publication
(10) Pub. No.: US 2009/0031698 A1
(43) Pub. Date: Feb. 5, 2009

(54) Liquid and Solid Biofueled Combined Heat and Renewable Power Plants

(75) Inventors: Terry L. Brown, Fayetteville, NY (US); George J. Mezey, Camillus, NY (US)

Correspondence Address: BOND, SCHOENECK & KING, PLLC, ONE LINCOLN CENTER, SYRACUSE, NY, 13202-1355, US

(73) Assignee: O'BRIEN & GERE ENGINEERS INC., East Syracuse, NY (US)

(21) Appl. No.: 12/183,141

(22) Filed: Jul. 31, 2008

Related U.S. Application Data
(60) Provisional application No. 60/952,959, filed on Jul. 31, 2007.

(51) Int. Cl. F02B 43/00

(52) U.S. Cl. 60/39.12

(57) ABSTRACT

The present invention relates generally to power plants, and, more particularly, to liquid and solid biofueled power plants that make renewable energy and utilize waste heat for a variety of applications including waste treatment plant processes, biofuel treatment and processing (e.g., sludge drying), fish farms, green houses, and the like.

### RELATED APPLICATION

The present application claims priority to U.S. provisional patent application No. 60/952,959, filed on Jul. 31, 2007, which is hereby incorporated by reference herein in its entirety.

### BACKGROUND OF THE INVENTION

1. Field of Invention

The present invention relates generally to power plants and more particularly, to liquid and solid biofueled power plants that make renewable energy and utilize waste heat for a variety of applications including waste treatment plant processes, biofuel treatment and processing (e.g., sludge drying), fish farms, green houses, and the like.

2. Description of Prior Art

Non-renewable energy sources include fossil fuels (coal, oil, natural gas), the combustion of which accounts for the majority of greenhouse gas emissions and other pollutants (e.g., NOx and SOx) in the United States.

In response to the inevitable consumption of these non-renewable fossil fuels and threats to the Earth's climate, an increased focus has been placed on alternative sources of energy including renewable energy sources.

Renewable energy is a term of art used to describe power derived from environmentally friendly sources of energy including renewable (or regenerative), non-polluting energy sources. (No source can be completely non-polluting, since any energy source requires an input of energy which creates some pollution.) Specific types of renewable energy include wind power, solar power, hydropower, geothermal power, and biomassibiofuel power.

Biomass (or solid biofuel) is a type of renewable energy source that includes solid plant matter created by plants through photosynthesis, a process which uses the sun's energy (along with water and atmospheric carbon dioxide) to produce glucose and oxygen. Biomass also includes biodegradable wastes such as sludge, which is the part of sewage that remains after the contaminants have been removed. Biomass may be converted into another type of renewable energy source, liquid biofuel. Liquid biofuel includes unprocessed vegetable oil, biodiesel, ethanol (including E85—a blend of 85% ethanol and 15% gasoline), and virgin and recycled animal parts.

Biodiesel is used as a substitute for petroleum diesel and can be produced from unprocessed vegetable oil (e.g., straight vegetable oil or waste vegetable oil) or animal fat through the process of transesterification (a process which should be appreciated by those skilled in the art and need not be repeated in detail herein). Briefly, vegetable oils are made of triglycerides, and the triglycerides are reacted with an alcohol (e.g., methanol or ethanol) in the presence of a catalyst (e.g., a strong base such as potassium hydroxide) to form a monoalkyl ester (e.g., methyl ester or ethyl ester—the biodiesel) and glycerol. Types of biodiesel include B100 (100% pure biodiesel) and B20 (20% biodiesel and 80% petroleum diesel).

Biodiesel is sometimes used as a source of renewable energy over straight or waste vegetable oil, because biodiesel is less viscous. The higher viscosity of the vegetable oils leads to problems such as incomplete combustion in a combustion engine. However, the processing of vegetable oil to make biodiesel requires an expenditure of chemical materials and energy, as outlined supra. Other than transesterfying unprocessed vegetable oil into biodiesel, the viscosity of the unprocessed vegetable oils may be reduced through the addition of heat.

Energy, in the form of stored chemical bond energy, from biomass or liquid biofuel is usually harvested through combustion and is used to create electricity and heat. Moreover, biomass and liquid biofuel are biodegradable and non-toxic. Combustion of biomass or liquid biofuel sends carbon (CO₂)—that was relatively recently converted by the plants from the atmosphere into glucose and is considered to be part of the carbon cycle—back into the atmosphere with substantially no net addition of carbon (i.e., “carbon neutral”) to the carbon cycle.

Cogeneration (also known as combined heat and power) refers to the combined production and utilization of electricity and heat energy, where the heat energy would normally be wasted, from a common fuel source. This “waste heat” is typically created as a byproduct during an industrial process. Instead of releasing this heat into the surrounding environment (and essentially treating this heat energy as waste heat), a cogeneration system will harness this heat energy for further uses. Cogeneration systems allow for the use of a higher percentage of energy obtained from a fuel source. This translates into fuel source conservation, since less of the fuel needs to be used to obtain the same amount of useful energy from the fuels source (as compared to a system that does not harness the waste heat). The efficiency of a cogeneration system increases when the heat that is obtained from a fuel source is utilized close to where the heat is created and harnessed. Further, the heat energy can be in the form of hot water or steam.

Sludge, as noted supra, is the solid part of sewage that remains after the contaminants and water have been removed at a waste treatment plant. These waste (or wastewater) treatment plants receive raw wastewater from a surrounding community and are designed to remove the contaminants from the wastewater and produce a “safe” liquid effluent and sludge that can be returned to the community environment. The sludge must be processed through several steps including bacteria digestion and drying. After the sludge is processed, it may be sent to a proper landfill or incinerated, and may be used for other purposes such as a fertilizer or soil conditioner. However, there are many difficulties involved in disposal or use of sludge, including environmental and regulatory issues.

### SUMMARY OF THE INVENTION

It is therefore a principal object and an advantage of the present invention to exploit renewable energy as opposed to fossil fuel sources.

It is another object and advantage of the present invention to use unprocessed vegetable oil as a fuel source where possible, since processing the vegetable oil into biodiesel requires an expenditure of chemical materials and energy.

It is a further object an advantage of the present invention to exploit such renewable energy in a cogeneration facility, where the biofuel could be utilized to its fullest potential.

It is another object an advantage of the present invention to provide a waste treatment plant that utilizes such a cogeneration facility in the processing and utilization of its sludge.

In accordance with the foregoing objects an advantages, an embodiment of the present invention provides power plants, and, more particularly, liquid and solid biofueled power plants that make renewable energy and utilize waste heat for a variety of applications including waste treatment plant processes, biofuel treatment and processing (e.g., sludge drying), fish farms, green houses.

In accordance with an embodiment of the present invention, power plants, and, more particularly, liquid and solid biofueled power plants that make renewable energy and utilize waste heat for a variety of applications including waste treatment plant processes, biofuel treatment and processing (e.g., sludge drying), fish farms, green houses, and the like are provided.

In accordance with an embodiment of the present invention, a renewable energy farm comprising a liquid and solid biofueled power plant located on a similar piece of property or at a similar geographic location as (i.e., very close to) a waste treatment facility, is provided.

In accordance with an embodiment of the present invention, a liquid biofueled portion of the power plant comprises tanks for storing the liquid biofuel, a processing and treatment facility for processing and treating the liquid biofuel, and a multiservice fuel station. The biofuel comprises unprocessed vegetable oil and waste cooking oil. The biofuel may also comprise biodiesel wherein the biodiesel is processed from the vegetable or waste cooking oil and comprises either B100 or B20 (and may comprise B5, or other biodiesel blends). The fuel treatment facility can process H₂ through electrolysis, wherein the treatment facility comprises a water line into the facility. The liquid biofueled portion provides liquid biofuel to systems comprising diesel and multi fuel engines, as discussed in more detail infra. These engines that utilize the liquid (or solid) biofuel source create renewable energy (electric power), and provide the electric power to the fuel treatment facility for many purposes including heating the vegetable oil and waste cooking oil tanks, filtering and treating the vegetable and waste cooking oil, creating biodiesel, and the other fuels mentioned supra. The renewable energy electric power is also provided to a substation and to a power grid to power other facilities.

In accordance with an embodiment of the present invention, these systems also harness the waste heat from the engines and provide this waste heat energy in the form of steam and hot water to willow and commercial green houses, waste treatment plant processes including digesters and sludge dryers, existing unused clarifier tanks that can be used for such purposes as a greenhouse operation, a fish farm operation, and a car wash operation, and to the solid biofuel process systems. CO₂ created during the combustion of these fuels is also harnessed and provided to the green houses.

In accordance with an embodiment of the present invention, the solid biofueled portion of the power plant comprises a fluidized bed reactor and syngas gasifier for creating syngas. The solid biofuel (or biomass) fuel source comprises willow (e.g., quick grow) and other wood materials. This willow is converted into syngas through this portion of the power plant which further comprises solid biofuel storage, solid biofuel drying, gas cooler, and gas cleaner. The syngas that is created through the gasification process is provided to gas engines which produces renewable energy (electric power). The electric power is provided to the fuel treatment facility for many purposes, as discussed supra. The renewable energy electric power is also provided to a substation and to a power grid to power other facilities. These engines (and the syngas gasifier) also harness the waste heat from the engines and provide this waste heat energy in the form of steam and hot water as discussed supra. CO₂ created during the gasification process is also harnessed and provided to the green houses. The sludge from the waste treatment plant is utilized as a fertilizer and soil conditioner for the willow that is grown, e.g., in the green houses.

In accordance with an embodiment of the present invention, gas engines are provided that are designed to run on synthetic (“syn”) gas.

In accordance with an embodiment of the present invention, diesel engines are provided that are designed to run on biofuels.

In accordance with an embodiment of the present invention, diesel engines are provided that are designed to run on a biofuel comprising unprocessed vegetable oil.

In accordance with an embodiment of the present invention, diesel engines are provided that are designed to run on a biofuel comprising biodiesel.

In accordance with an embodiment of the present invention, diesel engines are provided that are designed to run on a biofuel comprising unprocessed vegetable oil and natural gas, either separately or in combination.

In accordance with an embodiment of the present invention, a fuel comprising natural gas serves as a back-up fuel for the diesel engines, in case of an emergency.

In accordance with a preferred embodiment of the present invention, unprocessed vegetable oil comprises raw unprocessed soy oil.

In accordance with a preferred embodiment of the present invention, the diesel engines comprise medium or low speed diesel engines.

In accordance with an embodiment of the present invention, diesel engines comprising multi fuel engines may be housed within a renewable power plant facility, which can be located close to a waste treatment plant. More preferably, the renewable power plant facility will house multiple diesel engines. The diesel engines are connected to engine generator sets and heat recovery equipment (boilers for recovering the exhaust gas heat, and other heat recovery equipment). The renewable power plant facility may also house all the associated equipment for cooling the diesel engines, feeding and cleaning the lubricating oil for the engines, electrical interconnection equipment for connecting the generators to a power grid, and a steam turbine to generate additional power from the heat recovered from the engine exhaust. The steam turbine can have an extraction point to allow low pressure steam (e.g., from about 5 to about 150 psi, preferably 10 psi) to be extracted that can be used for building heating and interconnection to the heating system of the waste treatment plant so that none of the gas fired boilers, or other form of heating system existing at the waste treatment plant, need to be run (except for in an emergency).

In accordance with an embodiment of the present invention, biofuel is delivered to the renewable power plant via truck or by rail and off loaded into biofuel processing and storage facilities, which may be located within the walls of an existing out-of-service clarifier (or other available means of containment) of a waste treatment plant. This permits the construction of the renewable power plant facility without the need for extensive foundations and provides for secondary containment (even though none is required) of the fuels. At the storage portion of the facilities, unprocessed vegetable oil and waste cooking oil may be stored in tanks. At the fuel treatment portion of the facilities, the unprocessed vegetable oil and waste cooking oil can be filtered and treated to the standards required for engine use (which should be understood by those skilled in the art, and need not be repeated herein).

In accordance with an embodiment of the present invention, a biofuel processing system to convert vegetable oil into Biodiesel (B-100) through transesterfication can be housed in separate unused tanks. The reusable byproducts of this processing comprise glycerin and potash that can be either sold on the market or used in the biomass to renewable energy plant on waste beds, as described infra.

In accordance with an embodiment of the present invention, the renewable electrical power generated from the diesel engines and steam turbines can be connected to a main substation of a waste treatment plant which allows the renewable power plant to act as an emergency power supply in case of failure of the power company's system. It could as well be used as the primary power supply for the waste treatment plant. By tying the generating system to the power grid, the system has the capability to feed power to other user (or other geographic region created by a defined territorial division, for example) owned facilities, regardless of type so that the user can be completely “Renewable Energy Powered”.

In accordance with an embodiment of the present invention, the heat that remains after renewable power generation (mostly in the form of steam or hot water) can be utilized for processing the unprocessed vegetable oil or waste cooking oil into Biodiesel, keeping the tanks of unprocessed vegetable oil and waste cooking oil fuel warm, and for such other practical and revenue generating activities as converting other unused clarifiers into fish farms with temperature controlled water and, if needed, as a source of heating hot water for sludge digesters of the waste treatment plant.

In accordance with an embodiment of the present invention, the heat that remains after renewable energy power generation can also be used to dry sludge of the waste treatment plant to make it easier to transport and utilize as a soil conditioner and fertilizer for the renewable biomass, as mentioned supra and described infra.

In accordance with an embodiment of the present invention, commercial green houses can be built near the renewable power plant and the heat that remains after renewable power generation can be used to heat and cool the commercial green houses for optimum growth for hydroponics farming. In accordance with an embodiment of the present invention, this “waste” heat can also be used for a commercial car wash that can use the lowest temperature hot water.

In accordance with an embodiment of the present invention, biofuels can be coupled with selective catalyst reduction exhaust scrubber technologies (as understood by those of skill in the art) to assure that NOx, Sulphur, and particulate emissions from the renewable power plant will meet the most stringent Federal and State requirements. The scrubber technologies can also help close the carbon dioxide cycle in conformance with the Koto agreements for the lifetime of the renewable power plant.

In accordance with an embodiment of the present invention, a “Renewable Fuels Service Station” is provided that can make Biodiesel in blends such as B-5 and B-20 as well as B-100 and can act as a renewable fuels supplier for the other renewable fuels such as Ethanol E-85 and Hydrogen (which can be made by the combined heat and power plant). B-100 biodiesel is manufactured by transesterfication (as described supra), and can be blended with D-2 petroleum diesel in any ratio to produce from B99 (99% biodiesel) to B01 (1% biodiesel). Hydrogen is produced from excess electric power by electrolysis, as described supra. These renewable fuels can be made available to the users' owned and operated vehicles, and can be made available to the general public as well. At night, for example, or at any other time when power usage may be low, the extra “renewable energy power” can be utilized in a water electrolyzer to produce Hydrogen, and as a byproduct, medical Oxygen for sale in the public marketplace.

In accordance with an embodiment of the present invention, a biomass to renewable energy facility that will produce heat and power while reclaiming waste beds of a waste treatment or industrial process facility is provided. The sludge produced at the waste treatment plant and dried there can be utilized as a soil conditioner and fertilizer to allow for the planting and harvesting of “Quick Grow Willow” as the biomass fuel source for a synthetic gas manufacturing facility located near or on the waste beds.

In accordance with an embodiment of the present invention, willows are used as the biomass for many reasons including: willows are easily propagated from unrooted cuttings, high yields can be obtained in a few years, willows vigorously resprout after each harvest, the amount of energy in a dry ton of willow is similar to other hardwoods, a crop can be harvested six to seven times before replanting is required, willow crops reduce soil erosion and nonpoint source pollution, and the use of willow crops reduces the need for fossil fuels and petroleum products. Not only are willow crops carbon neutral, but combustion of willow biomass releases fewer acid-rain producing compounds into the atmosphere. Willows can be converted into a variety of sustainable environmentally-friendly resources, including: heat and electricity by direct combustion, and gasification; and biofuels.

In accordance with an embodiment of the present invention, this willow biomass (as well as other woody materials—solid plant biomass) can be converted by a process (oxygen starved combustion in the presence of steam) in a fluidized bed reactor into a synthetic gas (“SynGas”) that can be burned in gas engines to create even more “renewable power” and heat. A portion of the power created can be provided or sold to certain entities including schools and universities and governmental facilities allowing them to be “Renewable Energy Powered.” The remainder of the power created can be used in onsite green houses to grow the willow plant seedlings as well as in onsite commercial greenhouses. Any excess renewable power can be sold via the power grid to other customers wanting to buy renewable power.

In accordance with an embodiment of the present invention, the waste heat from the engines can be utilized for heating and cooling the greenhouses and for drying the biomass to feed to the SynGas process. The ash from the SynGas process can be spread on the land growing the willow to further enhance and fertilized the soil condition. The CO₂ created by the engine exhaust can be cooled, filtered and piped to the greenhouses to increase the ambient CO₂ levels in the air which has shown to increase greenhouse yields up to 40%.

### BRIEF DESCRIPTION OF THE DRAWINGS

The present invention will be more fully understood and appreciated by reading the following Detailed Description in conjunction with the accompanying drawings, in which:

FIG. 1 is a schematic view that illustrates a renewable energy farm, plant, or facility, according to an embodiment of the present invention.

FIG. 2 is schematic view that illustrates a biofuel storage, processing, and treatment facility according to an embodiment of the present invention.

FIG. 3 is a schematic view that illustrates a biomass to renewable energy facility according to an embodiment of the present invention.

### DETAILED DESCRIPTION

In accordance with an embodiment of the present invention, power plants, and, more particularly, liquid and solid biofueled power plants that make renewable energy and utilize waste heat for a variety of applications including waste treatment plant processes, biofuel treatment and processing (e.g., sludge drying), fish farms, green houses, and the like are provided.

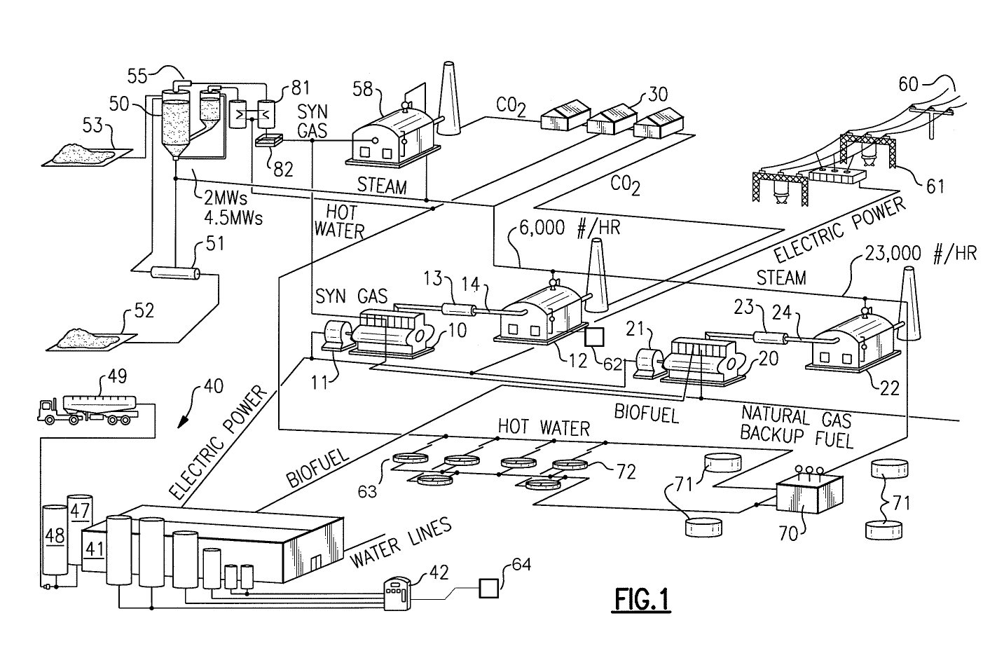

Referring to the drawings, wherein like reference numerals refer to like components, FIG. 1 shows a renewable energy farm, according to an embodiment of the present invention. The renewable energy farm comprises components of a combined heat and renewable power plant located in close proximity to a waste treatment center. The waste treatment center comprises a waste treatment plant building 70, waste treatment digesters 71, existing clarifier tanks 72, and a electrical substation 61.

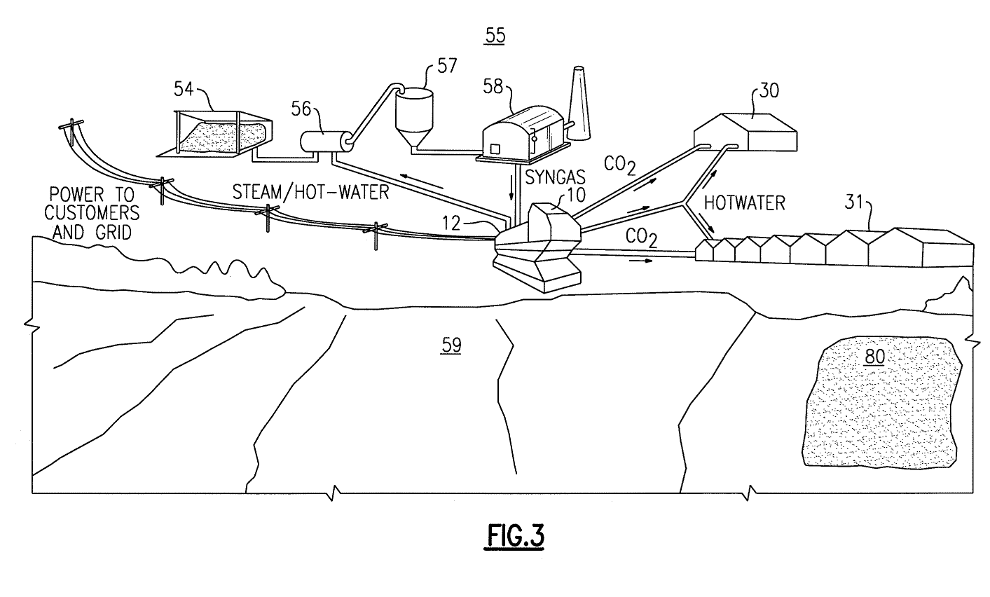

In accordance with an embodiment of the present invention, power plant components comprise a gas engine 10 connected to a generator 11, a waste heat recovery boiler 12 and a scrubber 13 attached to the connection mechanism (piping) 14. A steam turbine 62, used to generate additional power from the heat recovered from the engine exhaust, for example, is also provided. The steam turbine 62 can have an extraction point (not shown) to allow low pressure steam (e.g., from about 5 to about 150 psi, preferably 10 psi) to be extracted that can be used for building heating and interconnection to the heating system of a waste treatment plant so that none of the gas fired boilers, or other form of heating system existing at the waste treatment plant, need to be run (except for in an emergency). The gas engine receives syngas from a fluidized bed reactor 50 (a gasifier), as described infra. The syngas powers the gas engine which provides electric power through the generator 11 to the electrical substation 61 and the power grid 60 (which may provide renewable power to other facilities; see also FIG. 3) and the fuel treatment facility 41, which will be described infra. The waste heat recovery boiler 12 provides steam or hot water to the green houses 30, waste treatment plant building 70, waste treatment digesters 71, sludge dryer 51 and fluidized bed reactor 50. CO₂ and hot water can also be also provided to the willow green houses 30 and commercial green houses 31 (as shown in FIG. 3).

The power plant components also comprise a multi fuel engine 20, connected to a generator 21, a waste heat recovery boiler 22, a selective catalyst reduction exhaust scrubber 23, attached to the connection mechanism (piping) 24. The multi fuel engine 20 receives biofuel, such as unprocessed vegetable oil (preferably soy oil) or biodiesel, from a biofuel storage, processing, and treatment facility 40, as described infra. The multi fuel engine 20 also receives natural gas backup fuel. The biofuel and/or natural gas powers the multi fuel engine 20 which provides electric power through the generator 21 to the fuel treatment facility 41, the waste treatment plant building 70, the waste treatment digesters 71, the existing clarifier tanks 72, and the electrical substation 61 and the power grid 60. Both engines, 10 and 20, provide steam to the willow green houses 30, waste treatment plant building 70, waste treatment digesters 71, sludge dryer 51 and fluidized bed reactor 50.

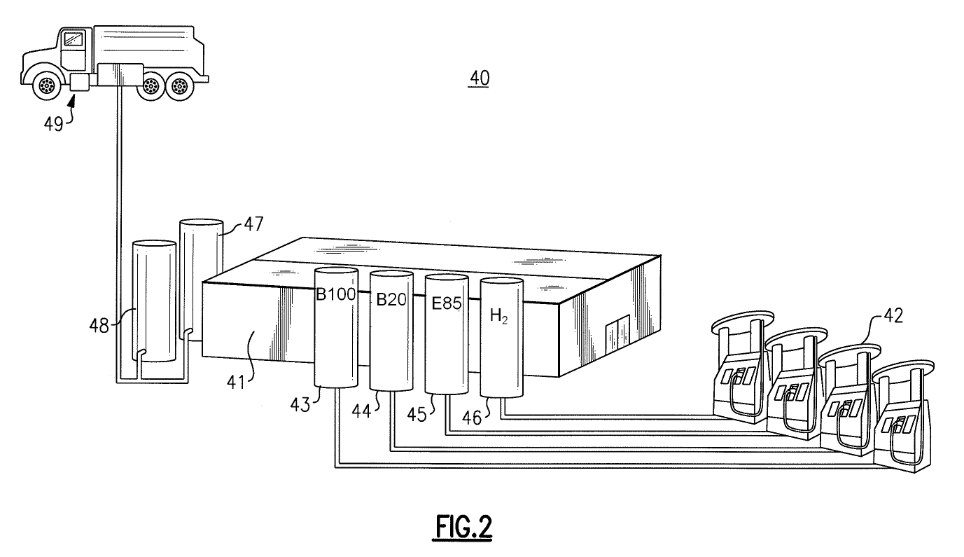

In accordance with an embodiment of the present invention, a biofuel treatment, processing, and treatment facility 40 is provided. As shown in FIGS. 1 and 2, the biofuel treatment, processing, and treatment facility 40 comprises a fuel treatment facility 41 for treating the unprocessed vegetable oil and waste cooking oil (which is stored in tanks 47 and 48, respectively and is delivered to the tanks by a fuel truck (or train) 49), performing hydrogen electrolysis for producing H₂ (as shown in FIG. 2 as tank 46), and processing the unprocessed vegetable oil and waste cooking oil into B100, B20, as shown in the FIG. 2 as tanks 43 and 44, respectively. A multi fuel service station 42 is also shown, which can offer B100, B20, H₂ and E85 (E85 can be obtained from an outside source 64). As noted above, the fuel treatment facility 41 receives electric power from generator 11 and 21 for its process power requirements. There is also a water line to the fuel treatment facility 41 for hydrogen electrolysis.

In accordance with an embodiment of the present invention, a biofuel processing system to convert vegetable oil into Biodiesel (B-100) through transesterfication can be housed in separate unused tanks 63, as shown in FIG. 1.

In accordance with an embodiment of the present invention, a biomass to renewable energy facility 55 is provided, wherein the biomass comprises willow and other woody materials. As shown in FIG. 1 and/or FIG. 3, the biomass to renewable energy facility 55 comprises a fluidized bed reactor 50, a sludge dryer 51 and sludge storage 52, a biofuel storage section 53, willow and wood chip receiving section 54, chip drying section 56, dry chip storage 57, syngas boiler 58, a gas cooler 81, and a gas cleaner 82. (Syngas boiler 58 and waste heat recovery boiler 12 can be one in the same). Quick grow willow farm on waste beds 59 and waste treatment plant sludge for willow fertilizer 80, is also shown in FIG. 3. The syngas derived from the biomass to renewable energy facility 55 is provided as fuel to the gas engine 10. Steam and CO₂ from the syngas boiler 58 and engine 10 are provided to the willow green houses 30 and the commercial green houses 31. Steam from the syngas boiler 58 is provided to the sludge dryer 51. Hot water from the gas cooler 81 is provided to the willow green houses 30 and existing unused clarifier tanks 72 (which may be used as a fish farm). Hot water is also provided to the willow green houses 30, commercial green houses 31, and waste treatment plant building 70 and digesters 71. Steam and hot water is provided to the chip drying section 56 by the waste heat recovery boiler 12, which is connected to the gas engine 10.

While several embodiments of the invention have been discussed, it will be appreciated by those skilled in the art that various modifications and variations of the present invention are possible. Such modifications do not depart from the spirit and scope of the invention.

What is claimed is:

1. A renewable energy generation system comprising:
a. a carbon containing renewable energy source;
b. a gasifier configured to convert said carbon containing renewable energy source into a syngas;
c. a generator configured to generate electric power;
d. a gas engine connected to said gasifier and to said generator, and configured to utilize said syngas as a source of energy for the generation of electric power through said generator;
e. a waste heat recovery boiler connected to said gas engine, configured to receive waste heat energy from said gas engine, and to provide the waste heat energy to at least one waste treatment plant processor.

2. The renewable energy generation system of claim 1, wherein the carbon containing renewable energy source comprises a solid biofuel.

3. The renewable energy generation system of claim 2, wherein the solid biofuel comprises a wood material.

4. The renewable energy generation system of claim 3, wherein said wood material comprises willow.

5. The renewable energy generation system of claim 1, wherein said at least one waste treatment plant processor comprises a processor selected from the group consisting of a waste treatment digester, a sludge dryer, and a clarifier tank.

6. The renewable energy generation system of claim 1, wherein the waste heat recovery boiler is configured to provide waste heat energy to at least one of said gasifier, a biofuel storage, processing and treatment facility, a waste treatment plant building, a greenhouse, a hydroponic system, or a fish farm.

7. The renewable energy generation system of claim 1, wherein the waste heat recovery boiler is configured to receive CO₂ from said gas engine, and to provide the CO₂ to at least one of a greenhouse, a hydroponic system, or a fish farm.

8. The renewable energy generation system of claim 2, further comprising a solid biofuel drying section, wherein the waste heat recovery boiler is configured to provide waste heat energy to said solid biofuel drying section.

9. The renewable energy generation system of claim 1, further comprising a steam turbine connected to said waste heat recovery boiler, wherein said steam turbine is configured to receive waste heat energy from said waste heat recovery boiler and to generate electrical power from said waste heat energy.

10. The renewable energy generation system of claim 1, wherein the generator is configured to provide electric power to at least one of a substation, power grid, waste treatment building, waste treatment digester, clarifier tank, greenhouse, or biofuel storage, processing and treatment facility.

11. The renewable energy generation system of claim 1, further comprising an exhaust scrubber connected to said gas engine configured to reduce pollutants emitted from said gas engine.

12. A renewable energy generation system comprising:
a. a carbon containing renewable energy source;
b. a biofuel storage, processing and treatment facility configured to store, process, and treat said carbon containing renewable energy source;
c. a generator configured to generate electric power;
d. a multi fuel engine connected to said biofuel storage, processing and treatment facility and to said generator, and configured to utilize said carbon containing renewable energy source as a source of energy for the generation of electric power through said generator;
e. a waste heat recovery boiler connected to said multi fuel engine, configured to receive waste heat energy from said multi fuel engine, and to provide the waste heat energy to at least one waste treatment plant processor.

13. The renewable energy generation system of claim 12, wherein the carbon containing renewable energy source comprises a liquid biofuel.

14. The renewable energy generation system of claim 13, wherein the liquid biofuel comprises biodiesel.

15. The renewable energy generation system of claim 13, wherein the liquid biofuel comprises waste cooking oil.

16. The renewable energy generation system of claim 13, wherein the liquid biofuel comprises unprocessed vegetable oil.

17. The renewable energy generation system of claim 16, wherein the unprocessed vegetable oil is raw unprocessed soy oil.

18. The renewable energy generation system of claim 12, wherein said at least one waste treatment plant processor comprises a processor selected from the group consisting of a waste treatment digester, a sludge dryer, and a clarifier tank.

19. The renewable energy generation system of claim 12, wherein the waste heat recovery boiler is configured to provide waste heat energy to at least one of said biofuel storage, processing and treatment facility, a waste treatment plant building, a greenhouse, a hydroponic system, or a fish farm.

20. The renewable energy generation system of claim 12, further comprising a steam turbine connected to said waste heat recovery boiler, wherein said steam turbine is configured to receive waste heat energy from said waste heat recovery boiler and to generate electrical power from said waste heat energy.

21. The renewable energy generation system of claim 12, wherein the generator is configured to provide electric power to at least one of a substation, power grid, waste treatment building, waste treatment digester, clarifier tank, greenhouse, or biofuel storage, processing and treatment facility.

22. The renewable energy generation system of claim 12, further comprising a natural gas energy source, and wherein said multi fuel engine is configured to utilize said natural gas energy source as a source of energy for the generation of electric power through said generator.

23. The renewable energy generation system of claim 12, further comprising an exhaust scrubber connected to said multi fuel engine configured to reduce pollutants emitted from said multi fuel engine.

24. The renewable energy generation system of claim 12, wherein the waste heat recovery boiler is configured to receive CO₂ from said multi fuel engine, and to provide the CO₂ to at least one of a greenhouse, a hydroponic system, or a fish farm.

25. A renewable energy power plant, comprising:
a. a liquid biofuel segment comprising:
i. a liquid biofuel energy source;
ii. a biofuel storage, processing and treatment facility configured to store, process, and treat said liquid biofuel energy source;
iii. a first generator configured to generate electric power;
iv. a multi fuel engine connected to said biofuel storage, processing and treatment facility and to said generator, and configured to utilize said liquid biofuel energy source as a source of energy for the generation of electric power through said first generator;
v. a first waste heat recovery boiler connected to said multi fuel engine, configured to receive waste heat energy from said multi fuel engine, and to provide the waste heat energy to at least one waste treatment plant processor; and
b. a solid biofuel segment comprising:
i. a solid biofuel energy source;
ii. a gasifier configured to convert said solid biofuel energy source into a syngas;
iii. a second generator configured to generate electric power;
iv. a gas engine connected to said gasifier and to said second generator, and configured to utilize said syngas as a source of energy for the generation of electric power through said second generator;
v. a second waste heat recovery boiler connected to said gas engine, configured to receive waste heat energy from said gas engine, and to provide the waste heat energy to at least one waste treatment plant processor.
